(19) United States
(12) Patent Application Publication
(10) Pub. No.: US 2020/0390657 A1
(43) Pub. Date: Dec. 17, 2020

(54) FEEDING BOTTLE ADAPTOR

(71) Applicant: San Hwa GOH, Singapore (SG)

(72) Inventors: Mattityahu AVSHALOMOV, Ramat Gan (IL); San Hwa GOH, Singapore (SG)

(21) Appl. No.: 16/903,450

(22) Filed: Jun. 17, 2020

Related U.S. Application Data
(60) Provisional application No. 62/862,142, filed on Jun. 17, 2019.

(51) Int. Cl. A61J 9/04; A61J 9/06

(52) U.S. Cl. CPC A61J 9/04; A61J 9/0607

(57) ABSTRACT

An adaptor for a feeding bottle and a method of using same, the bottle including a ring with a lower side, an upper side, an inner side and an outer side, the lower side substantially flat, at least a portion of the lower side configured to rest on a rim of the bottle; the ring comprising at least one slot on its lower side; an outer edge of said at least one slot being at said outer side of the ring, the slot not extending to the inner side of the ring; and a cylindrical portion having an upper side, a lower side, an inner side and an outer side, the upper side integral with a portion of the lower side of said ring; the cylindrical portion depending from the ring; the cylindrical portion configured to be positionable within the bottle and with the outer side close to an inner side of said bottle, an upper portion of the inner side of the cylindrical portion substantially parallel to a lowermost portion of the inner side of the ring; the cylindrical portion comprising at least one aperture, the at least one aperture having two sides, the at least one aperture passing entirely through said cylindrical portion; each of the two sides of the at least one aperture terminating in an inner side edge on the inner side of the cylindrical portion, an outer side edge on the outer side of the cylindrical portion and a bottom edge on the bottom side of the cylindrical portion; wherein at least an upper portion of the outer side of the cylindrical portion subtends an angle θ with respect to the inner side of the bottle; wherein each of the inner edges of the at least one aperture and each of the outer edges of the at least one aperture subtends an angle φ with a vertical perpendicular to the inner edge of the bottom side of the cylindrical portion; further wherein each of the bottom edges subtends an angle ρ with a horizontal perpendicular to the outer edge of the bottom side of the cylindrical portion.

### FIELD OF THE INVENTION

The present invention generally pertains to a system and method for adapting a conventional feeding bottle to so that pressure within the bottle remains substantially the same as pressure outside the bottle as fluid is withdrawn from the bottle.

### BACKGROUND OF THE INVENTION

Bottle-feeding is commonly used with babies, as means of providing formula milk to replace breastfeeding, as a means of providing an infant with its mother's milk when the mother is not present, and as a means of providing the infant with liquids other than mothers' milk, such as water or juice.

However, as liquid is withdrawn from the bottle, either air must enter the bottle or the bottle must collapse in order to maintain equilibrium pressure between the inside and the outside of the bottle since the larger the pressure differential between the inside and the outside of the bottle, the more difficult the removal of liquid from the bottle. Typically, air will enter the bottle via the nipple, from the baby's mouth. However, this can result in the baby swallowing air, which can lead to a “gassy” baby, spit-up, colic, and ear infections.

Swallowing of air can be prevented by venting the bottle or by having a collapsible bottle.

The Joovy® BOOB™ uses a venting ring, the CleanFlow™ Vent, that goes onto the opening of the bottle before you screw on the nipple. The vent ring has four equally-spaced holes in a silicone sleeve that fits into the bottle. The silicone sleeve is integral with a hard plastic top that sits on the lid of the bottle. The CleanFlow Vent is notched to fit perfectly in the Boob Baby Bottle's wide neck, which eliminates over and under tightening, reducing leaks and maintaining consistent flow rates.

However, the vent ring will only fit into the Joovy BOOB bottle.

Dr. Brown's® bottles have an air vent that redirects air bubbles from the nipple to the back of the bottle as a baby feeds. But liquid can exit the bottle through the vent if the bottle is not handled properly. The Doctor Brown bottle also has two extra parts, which can be fussy to clean and which take extra time to fit together and to fir into the bottle. The Comotomo® bottle and the Minbie® Newborn BPA-free Baby Bottle have two small vents positioned at the base of the nipple. The Tommee Tippee® has a single vent on the nipple. In some cases, a vent can be covered by the cheek, lips, or chin, reducing the effectiveness of the venting system or, in the case of the Tommee Tippee, preventing venting entirely.

The Philips® Avent™ has twin valves, venting through tiny slits at the very far edges of the nipple.

The MAM® anti-colic baby feeding bottle has a vent on the base. The bottle separates into nipple, nipple ring, bottle, and vented base. The base screws onto the bottom, then you place the nipple onto the top of the bottle, and then screw on the nipple ring.

Other baby feeding bottles with vent on the base include the Playtex® Ventaire™ Baby Bottles.

The Munchkin® LATCH™ Baby Bottle also vented via the bottom of the bottle, with a valve instead of a vent.

The Flipsi® Natural Silicone Baby bottle has a silicone cup-like reservoir that is filled with milk and placed into the bottle, after which, the nipple is screwed on. The silicone sits over the top edge of the bottle, so when the nipple cap is screwed on a very nice seal is formed. The flexible silicone is highly conformable, making it shrink in size to accommodate the decreasing amount of milk in the bottle.

The BIBIGO© bottle is has bellows-style sides, so that it is collapsible, reducing in size as liquid is removed from the bottle, the bottle size adjusting automatically to the volume of liquid left. Reducing the amount of air in the bottle, reduces the amount of air swallowed which provides effective and proactive colic relief.

It is therefore a long felt need to provide a venting means which is simple to use, vents reliably, does not block, does not leak and which is not limited to a single brand of bottle.

### SUMMARY OF THE INVENTION

It is an object of the present invention to disclose a system for adapting a conventional feeding bottle to so that pressure within the bottle remains substantially the same as pressure outside the bottle as fluid is withdrawn from the bottle.

It is another object of the present invention to disclose an adaptor for a feeding bottle, comprising:
a ring with a lower side, an upper side, an inner side and an outer side, said lower side substantially flat, at least a portion of said lower side configured to rest on a rim of said bottle; said ring comprising at least one slot on its lower side; an outer edge of said at least one slot being at said outer side of said ring, said slot not extending to said inner side of said ring; and
a cylindrical portion having an upper side, a lower side, an inner side and an outer side, said upper side integral with a portion of said lower side of said ring; said cylindrical portion depending from said ring; said cylindrical portion configured to be positionable within said bottle and with said outer side close to an inner side of said bottle, an upper portion of said inner side of said cylindrical portion substantially parallel to a lowermost portion of said inner side of said ring; said cylindrical portion comprising at least one aperture, said at least one aperture having two sides, said at least one aperture passing entirely through said cylindrical portion; each of said two sides of said at least one aperture terminating in an inner side edge on said inner side of said cylindrical portion, an outer side edge on said outer side of said cylindrical portion and a bottom edge on said bottom side of said cylindrical portion;
   wherein at least an upper portion of said outer side of said cylindrical portion subtends an angle θ with respect to said inner side of said bottle;
   wherein each of said inner edges of said at least one aperture and each of said outer edges of said at least one aperture subtends an angle φ with a vertical perpendicular to said inner edge of said bottom side of said cylindrical portion;
   further wherein each of said bottom edges subtends an angle ρ with a horizontal perpendicular to said outer edge of said bottom side of said cylindrical portion.

It is another object of the present invention to disclose the as described above, wherein said aperture is selected from of a group consisting of: a slit ending at said bottom edge of said cylindrical portion, a slit-shaped hole, and any combination thereof.

It is another object of the present invention to disclose the as described above, wherein said angle θ is less than 20°.

It is another object of the present invention to disclose the as described above, wherein said angle φ is in a range between 10 degrees and 80 degrees.

It is another object of the present invention to disclose the as described above, wherein said angle ρ is in a range between 10 degrees and 80 degrees.

It is another object of the present invention to disclose the as described above, wherein said at least one aperture is either a slit or a hole.

It is another object of the present invention to disclose the as described above, wherein said at least one slot is either a slit or a hole.

It is another object of the present invention to disclose the as described above, wherein said at least one slot has a width selected from a group consisting of: wider at the top than the bottom on the outside, wider at the bottom than the top on the outside, and the same width at the top and the bottom on the outside.

It is another object of the present invention to disclose the as described above, wherein said at least one slot has a width selected from a group consisting of: wider at the top than the bottom on the inside, wider at the bottom than the top on the inside, and the same width at the top and the bottom on the inside.

It is another object of the present invention to disclose the as described above, wherein said at least one aperture has a width selected from a group consisting of: wider at the top than the bottom on the outside, wider at the bottom than the top on the outside, and the same width at the top and the bottom on the outside.

It is another object of the present invention to disclose the as described above, wherein said at least one aperture has a width selected from a group consisting of: wider at the top than the bottom on the inside, wider at the bottom than the top on the inside, and the same width at the top and the bottom on the inside.

It is another object of the present invention to disclose the as described above, wherein said adaptor comprises hydrophobic material.

It is another object of the present invention to disclose the as described above, wherein said aperture has a width of less than 0.2 mm.

It is another object of the present invention to disclose a method for enabling feeding from a feeding bottle with a nipple, comprising steps of:
providing a conventional feeding bottle comprising a bottle portion, a nipple and a collar,
   said collar reversibly fastenable to said bottle portion, said collar configured to retain said nipple in juxtaposition with said bottle portion;
providing an adaptor for said bottle, said adaptor comprising:
   a ring with a lower side, an upper side, an inner side and an outer side, said lower side substantially flat, at least a portion of said lower side configured to rest on a rim of said bottle; said ring comprising at least one slot on its lower side; an outer edge of said at least one slot being at said outer side of said ring, said slot not extending to said inner side of said ring; and
   a cylindrical portion having an upper side, a lower side, an inner side and an outer side, said upper side integral with a portion of said lower side of said ring; said cylindrical portion depending from said ring; said cylindrical portion configured to be positionable within said bottle and with said outer side close to an inner side of said bottle, an upper portion of said inner side of said cylindrical portion substantially parallel to a lowermost portion of said inner side of said ring;
      said cylindrical portion comprising at least one aperture, said at least one aperture having two sides, said at least one aperture passing entirely through said cylindrical portion; each of said two sides of said at least one aperture terminating in an inner side edge on said inner side of said cylindrical portion, an outer side edge on said outer side of said cylindrical portion and a bottom edge on said bottom side of said cylindrical portion;
      at least an upper portion of said outer side of said cylindrical portion subtending an angle θ with respect to said inner side of said bottle;
      each of said inner edges of said at least one aperture and each of said outer edges of said at least one aperture subtending an angle φ with a vertical perpendicular to said inner edge of said bottom side of said cylindrical portion; and
      each of said bottom edges subtends an angle ρ with a horizontal perpendicular to said outer edge of said bottom side of said cylindrical portion;
   placing said adaptor in communication with said bottle portion, with said ring on said rim of said bottle portion and said cylindrical portion within said bottle portion,
   placing said nipple in communication with said adaptor;
   placing said collar over said nipple; and
   fastening said collar to said bottle portion;
   thereby providing a non-leaking feeding apparatus.

It is another object of the present invention to disclose the method as described above, additionally comprising a step of selecting said aperture from of a group consisting of: a slit ending at said bottom edge of said cylindrical portion, a slit-shaped hole, and any combination thereof.

It is another object of the present invention to disclose the method as described above, additionally comprising a step of selecting said angle θ to be less than 20°.

It is another object of the present invention to disclose the method as described above, additionally comprising a step of selecting said angle φ to be in a range between 10 degrees and 80 degrees.

It is another object of the present invention to disclose the method as described above, additionally comprising a step of selecting said angle ρ to be in a range between 10 degrees and 80 degrees.

It is another object of the present invention to disclose the method as described above, additionally comprising a step of selecting said at least one aperture to be either a slit or a hole.

It is another object of the present invention to disclose the method as described above, additionally comprising a step of selecting said at least one slot to be either a slit or a hole.

It is another object of the present invention to disclose the method as described above, additionally comprising a step of selecting a width of said at least one slot from a group consisting of: wider at the top than the bottom on the outside, wider at the bottom than the top on the outside, and the same width at the top and the bottom on the outside.

It is another object of the present invention to disclose the method as described above, additionally comprising a step of selecting a width of said at least one slot from a group consisting of: wider at the top than the bottom on the inside, wider at the bottom than the top on the inside, and the same width at the top and the bottom on the inside.

It is another object of the present invention to disclose the method as described above, additionally comprising a step of selecting a width of said at least one aperture from a group consisting of: wider at the top than the bottom on the outside, wider at the bottom than the top on the outside, and the same width at the top and the bottom on the outside.

It is another object of the present invention to disclose the method as described above, additionally comprising a step of selecting a width of said at least one aperture from a group consisting of: wider at the top than the bottom on the inside, wider at the bottom than the top on the inside, and the same width at the top and the bottom on the inside.

It is another object of the present invention to disclose the method as described above, additionally comprising a step of comprising said adaptor of hydrophobic material.

It is another object of the present invention to disclose the method as described above, additionally comprising a step of selecting a width of said at least one said aperture to be less than 0.2 mm.

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1A-B, FIG. 2A-B and FIG. 3 show examples of the prior art;

FIG. 4 schematically illustrates an exploded view of the adaptor of the present invention in position in a conventional baby feeding bottle;

FIGS. 5A-C schematically illustrate different sizes of conventional baby feeding bottles, each with the adaptor of the present invention in position;

FIG. 6 shows a schematic cutaway view of a baby drinking from a feeding bottle equipped with the adaptor of the present invention;

FIG. 7 shows a schematic enlarged view of the region inside circle A of FIG. 6;

FIG. 8 shows a schematic enlarged view of the adaptor in place;

FIG. 9 shows a perspective view of an embodiment of an adaptor;

FIG. 10 shows an enlarged perspective view of the embodiment of an adaptor of FIG. 9;

FIGS. 11-13 show schematic plan (top) views of embodiments of the adaptor;

FIG. 14 shows a schematic side view, from the outside, of a section of an embodiment of the adaptor; and

FIG. 15 shows a schematic perspective view, looking upward from the outside, of a section of an embodiment of the adaptor.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for adapting a conventional baby feeding bottle to so that pressure within the feeding bottle remains substantially the same as pressure outside the feeding bottle as fluid is withdrawn from the feeding bottle, with the bottle not leaking fluid via the vents.

The term ‘feeding bottle’ or ‘baby feeding bottle’ hereinafter refers to a conventional device for feeding liquids, typically to babies but sometimes used for older persons. The feeding bottle comprises a bottle portion, typically with a screw top, a collar and a nipple. The feeding bottle is assembled for use by placing the nipple on the upper rim of the bottle, placing the collar over the nipple so that the nipple protrudes from a hole in the collar, and fastening the collar securely to the bottle portion. Typically, the collar is screwed onto the bottle. However, the adaptor of the present invention can be used with feeding bottles with other types of fastener, such as a clip fastener.

The term ‘bottle’ or ‘bottle portion’ hereinafter refers to the part of a conventional feeding bottle in which the liquid is held before dispensing via the nipple.

The term ‘slit’ hereinafter refers to an opening which has one side reaching a bottom side of a portion of the device, so that the bottom edges of the sides of the opening are not joined. Fluid can flow inside-to-outside (back-to-front), outside-to-inside (front-to-back) through a slit, and can also flow through the bottom of a slit.

The term ‘hole’ hereinafter refers to an opening which has all four sides joined. No part of the opening reaches the bottom of the portion of the device. Fluid can flow inside-to-outside (back-to-front) or outside-to-inside (front-to-back) through a hole; fluid can not flow through the bottom of a hole.

The term ‘about’ hereinafter refers to a range of plus or minus 10% around the quoted value.

The present invention provides a non-leaking, non-blocking adaptor that can be used with a conventional feeding bottle with conventional nipple of the type typically used to feed babies.

The adaptor allows entry of air into the feeding bottle, while preventing leakage of fluid from the feeding bottle. The adaptor has a simple structure and is easy to clean and easy to sterilize.

There are a large number of devices in the market intended to allow an infant to drink from a feeding bottle while preventing the infant from ingesting air. Ingestion of air can cause health problems for the infant, including spitting up, colic and an increased incidence of ear infections.

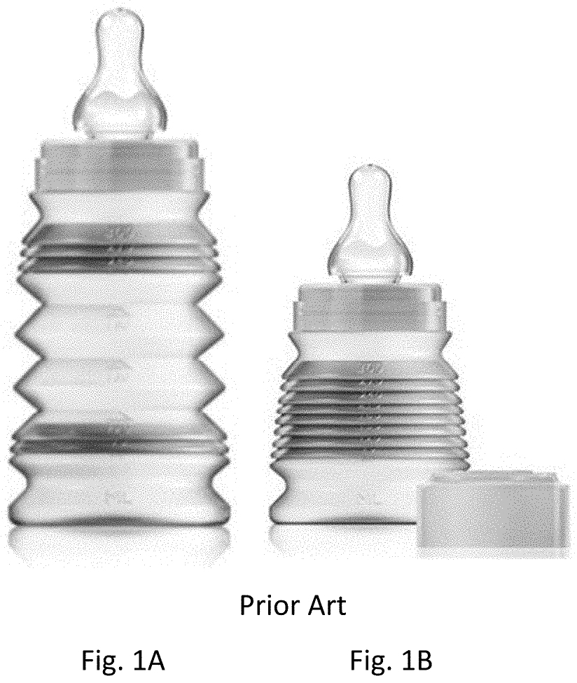

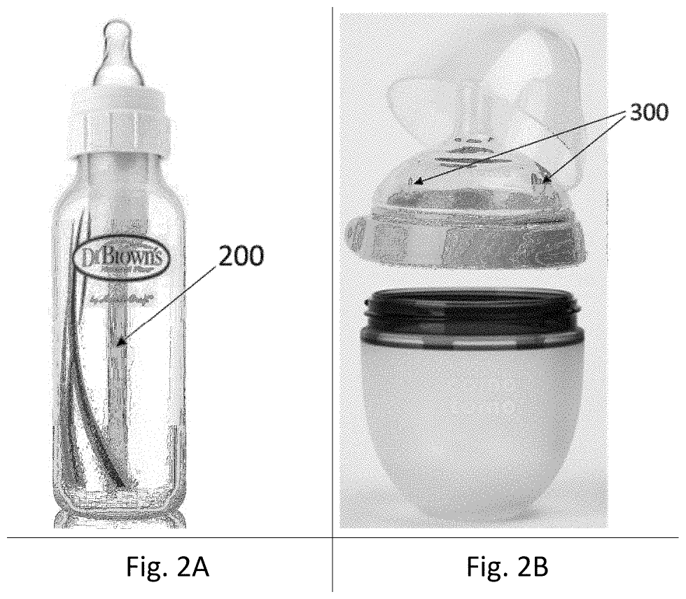

FIGS. 1-3 show examples of the prior art. FIG. 1A-B shows a collapsible feeding bottle, where the sides are configured to collapse in a bellows-like manner. In FIG. 1A the bottle is shown in a partly-expanded configuration, in FIG. 1B, it is in a fully-collapsed configuration. As liquid is removed from the feeding bottle via the nipple, the sides collapse, thereby preventing the need for air to enter the feeding bottle.

FIG. 2A shows a prior-art feeding bottle which comprises a tube (200) reaching from near the nipple to near the base of the feeding bottle. The tube conducts air entering through the nipple to the region at the base of the feeding bottle, so that the infant does not swallow the air.

FIG. 2B shows an example of a prior-art feeding bottle where the nipple comprises vents (300) near the edge of the nipple, away from the mouth of the infant. Air can enter the feeding bottle via the vents (300). As the vents (300) are near the edge of the nipple, the infant will not swallow the air.

FIG. 3 shows an example of a feeding bottle with a prior-art adaptor (100). The adaptor has a flexible ring portion that sits on the rim of the bottle (130), between the bottle (130) and the nipple (not shown), and a rigid cylindrical portion (120) which depends from the ring portion and rests inside the bottle (130). The cylindrical portion comprises two holes (125), passing perpendicularly through the cylindrical portion, which allow passage of air from the exterior of the feeding bottle to its interior.

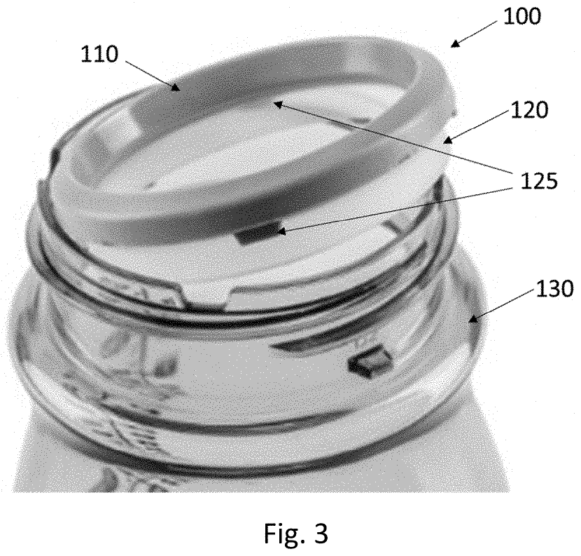

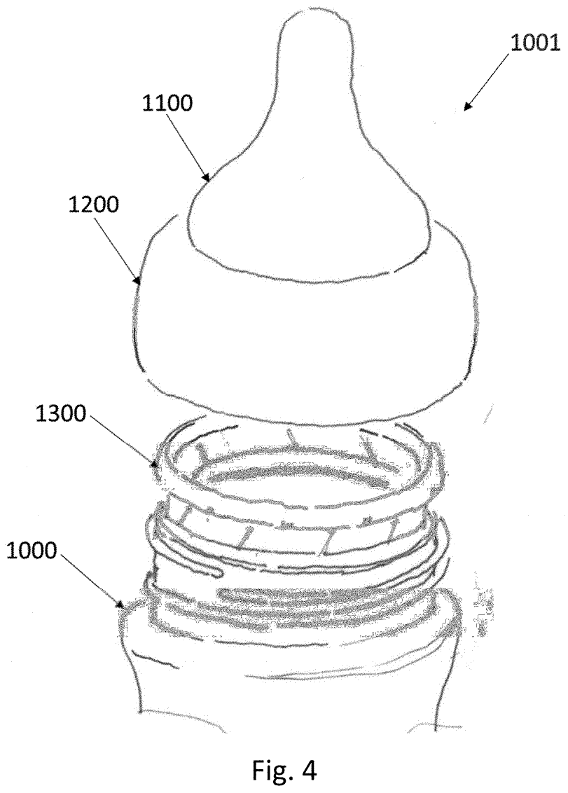

FIG. 4 shows a schematic perspective view of an embodiment of a feeding bottle (1001) which includes the adaptor (1300) of the present invention. The feeding bottle (1001) is a conventional feeding bottle, comprising a bottle (1000), a nipple (1100) and a collar (1200). The adaptor (1300) sits between the nipple (1100) and the bottle (1000), and the nipple (1100) and adaptor (1300) are held in place by the collar (1200).

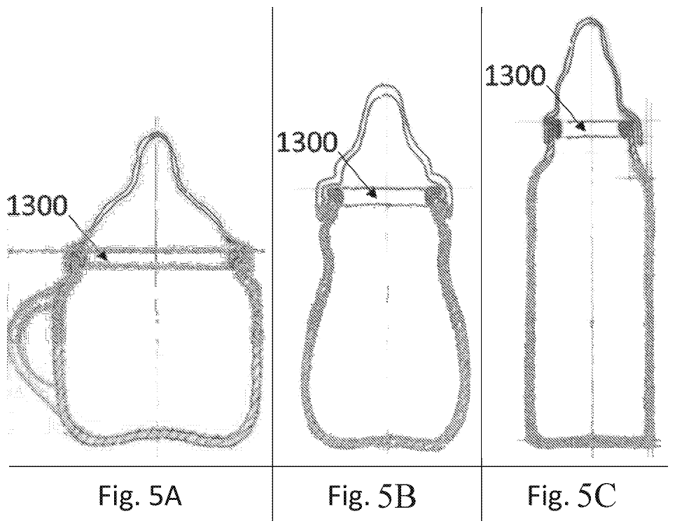

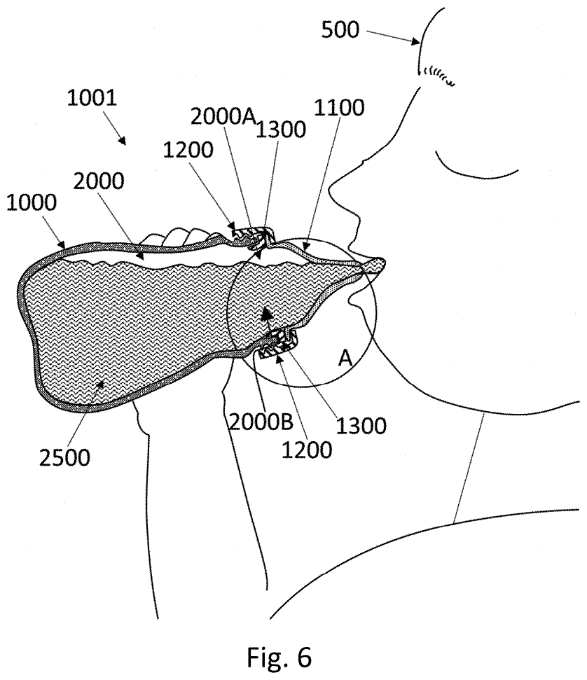

FIGS. 5A-C schematically illustrate that the adaptor (1300) can be manufactured in different sizes to fit the different sizes and shapes of conventional baby feeding bottles. FIG. 6 shows a schematic cutaway view of a baby (500) drinking from a feeding bottle (1001) equipped with the adaptor (1300) of the present invention, with the bottle (1000) partially filled with liquid (2500), with the remainder of the bottle (1000) filled with air (2000). The nipple (1100) is in the baby's (500) mouth and liquid is entering the baby's mouth. The space formerly filled by the liquid is replaced by air entering (arrows 2000A, 2000B) the bottle (1001) via the adaptor (1300). The nipple (1100) and adaptor (1300) are held in place by a collar (1200).

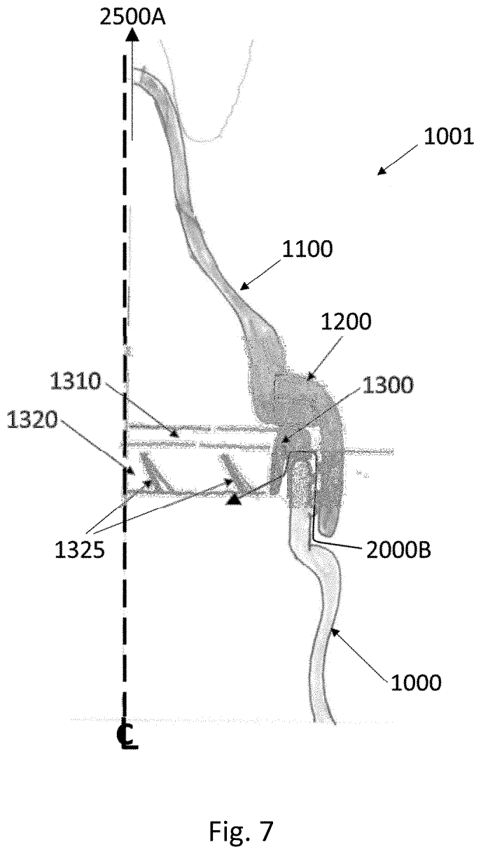

FIG. 7 shows a schematic enlarged view of the region inside circle A of FIG. 6, showing only half of the bottle (1000). The adaptor (1300) comprises a ring (1310) integral with a cylindrical portion (1320). The ring (1310) is configured to sit on the rim of a bottle (1000), with the cylindrical portion (1320) depending from the ring (1310) and configured to rest just inside the bottle (1000). The rim (1310) comprises slots (not shown) cut into its lower side, the slots deep enough to reach beyond the inner edge of the bottle (1000) rim when the adaptor (1300) is in place. The cylindrical portion (1320) comprises at least one aperture (1325) passing entirely through the cylindrical portion (1320) and oriented at an angle to the vertical.

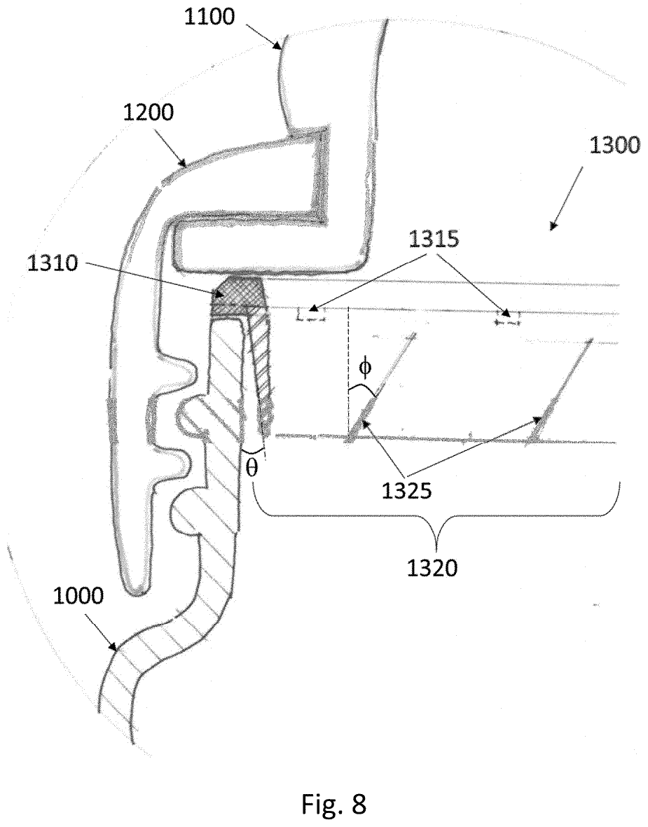

The illustration shows liquid (2500A) exiting via the nipple (1100), while air enters (2000B) the feeding bottle (1001) by passing through gaps between the screw threads in the collar (1200) and the screw threads in the bottle (1000), through at least one slot (not shown) on the lower side of the ring (1310) of the adaptor (1300) and then through the at least one aperture (1325) in the cylindrical portion (1320) of the adaptor (1300). FIG. 8 shows a schematic enlarged view of the adaptor in place. The bottle (1000), nipple (1200) and adaptor (1300) are held together by a collar (1200). The ring (1310) of the adaptor (1300) rests on the rim of the bottle (1000), sitting between the bottle (1000) rim and the base of the nipple (1100). The cylindrical portion (1320) of the adaptor (1300) sits inside the bottle, with a small gap between the outside edge of the top of the cylindrical portion (1320) and the inside edge of the bottle (1000) rim. In preferred embodiments, the outside of the cylindrical portion (1320) is not parallel to the inside of the bottle; the outside of the cylindrical portion (1320) subtends a small angle, θ, with the inside of the bottle. This small angle makes it easier to put in and remove the adaptor (1300) from the bottle (1000). Typically the angle θ is in a range from 0 to 30′; preferably, in a range from 5° to 20°, more preferably, about 10°.

In the schematic of FIG. 8, the positions of the slots (1315) in the rim (1310) can be seen. The slots do not pass entirely through the rim (1310); they do not penetrate the interior side of the ring (1310).

In this embodiment, the apertures (1325) are slits reaching the base of the cylindrical portion (1320). In some embodiments, at least one of the apertures (1325) is a narrow hole that does not reach the base of the cylindrical portion (1320). In all embodiments, the apertures (1325) make an angle φ with the vertical. The angle φ can be in a range from about 10° to about 80°, preferably in a range from about 20° to about 50°, most preferably, about 30°. The apertures (1325) can have parallel sides, or they can narrow from bottom to top. In some embodiments, the apertures (1325) are triangular in cross-section.

The number of apertures (1325) can be in a range from 1 to about 40. Preferably, the number of apertures (1325) is in a range from about 4 to about 20. More preferably, the number of apertures (1325) is in a range from 6 to 18.

The maximum width of an aperture (1325) is about 0.2 mm A slot can be wider at the top than the bottom on the outside, wider at the bottom than the top on the outside, and the same width at the top and the bottom on the outside.

A slot can be wider at the top than the bottom on the inside, wider at the bottom than the top on the inside, and the same width at the top and the bottom on the outside.

An aperture can be wider at the top than the bottom on the outside, wider at the bottom than the top on the outside, and the same width at the top and the bottom on the outside.

An aperture can be wider at the top than the bottom on the inside, wider at the bottom than the top on the inside, and the same width at the top and the bottom on the outside.

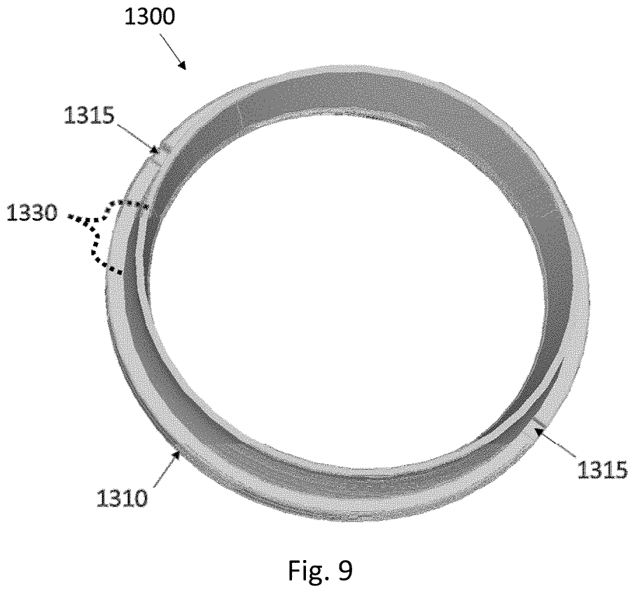

FIG. 9 shows a schematic perspective view of an embodiment of the adaptor (1300) with two slots (1315) in the ring (1310). The slots (1315) do not pass entirely through the ring (1310); they terminate at the outer edge of the cylindrical portion (1320). The number of slots (1315) can be in a range from one to 50. Preferably, the number of slots (1315) is in a range from about 4 to about 20. More preferably, the number of slots (1315) is in a range from 6 to 18. The apertures are not shown.

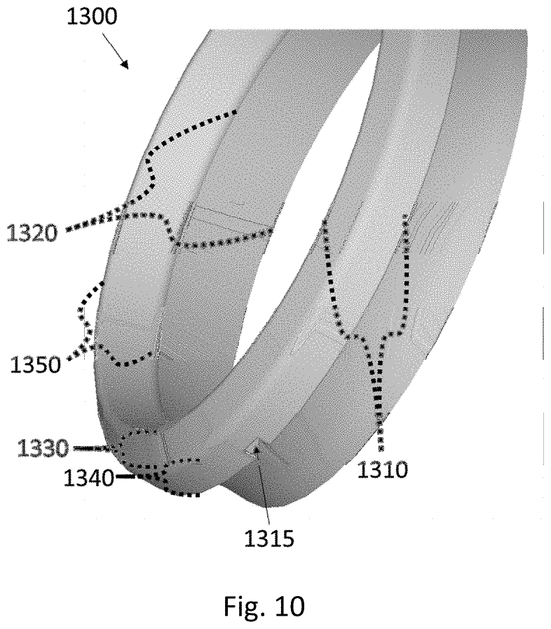

FIG. 10 shows an enlarged schematic perspective view of the embodiment of the adaptor (1300) of FIG. 9. One of the slots (1315) in the ring (1310) is visible. The cylindrical portion (1320) extends downward from the ring (1310). The upper part of the ring (1310) comprises 3 portions. In the center of the top surface is the central bearing surface (1330), the area where, in use, the ring (1310) will first contact the base of the nipple (1100). Preferably, the ring (1310) narrows both outward (1340) and inward (1350) of the central bearing surface (1330).

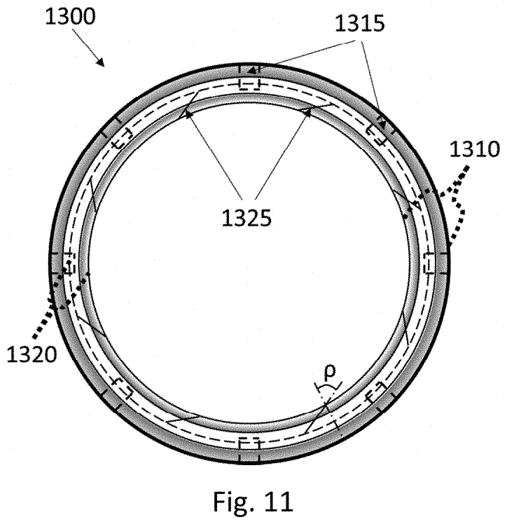

FIG. 11 shows a schematic plan (top) view of an embodiment of the adaptor (1300). The outer and inner shaded areas indicate the outer (1340) and inner (1350) narrowing regions, where the ring (1310) narrows from the thickness of the central bearing surface (1330. The ring (1310) has 8 slots (1315) (only 2 are labelled) and the cylindrical portion (1320) has 8 apertures (1325) (only 2 are labelled), each aperture (1325) being halfway between adjacent slots (1315). The 13 outer edge of the cylindrical portion (1320) is indicated by the dashed circle. The inner edges of the slots (1315) extend beyond the outer edge of the cylindrical portion (1320). The apertures (1325) extend entirely through the cylindrical portion (1320).

In a typical embodiment, the apertures (1325) do not cut perpendicularly through the cylindrical portion (1320); the sides, which cut through the cylindrical portion (1320), are not perpendicular to the inner (or outer) wall of the cylindrical portion (1320), but subtend an angle ρ, as shown in FIG. 11, with a perpendicular to the inner wall of the cylindrical portion (1320).

In embodiments with the same number of slots as apertures, the apertures can be in any position relative to the slots. More preferably, an aperture is halfway between adjacent slots.

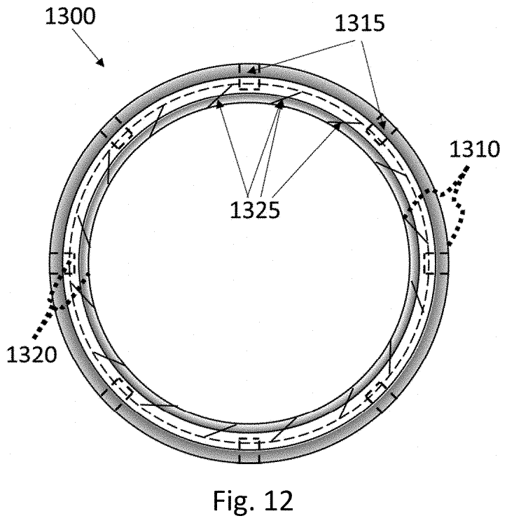

FIG. 12 shows a schematic plan (top) view of another embodiment of the adaptor (1300 The outer and inner shaded areas indicate the outer (1340) and inner (1350) narrowing regions, where the ring (1310) narrows from the thickness of the central bearing surface (1330. The ring (1310) has 8 slots (1315) (only 2 are labelled) and the cylindrical portion (1320) has 16 apertures (1325) (only 3 are labelled). The center of the first of each pair of apertures (1325) is ⅓ of the way between adjacent slots (1315), while the center of the second of the pair of apertures (1325) is ⅔ of the way between the adjacent slots (1315). In other words, the apertures (1325) in these embodiments are rotated by ½ of the angular distance between the apertures (1325) relative to the slots (1315). In the example of FIG. 12, the apertures are rotated by 11.25° (half of the 22.5° separation between apertures) relative to the slots (1315). The outer edge of the cylindrical portion (1320) is indicated by the dashed circle. The inner edges of the slots (1315) extend beyond the outer edge of the cylindrical portion (1320). The apertures (1325) extend entirely through the cylindrical portion (1320).

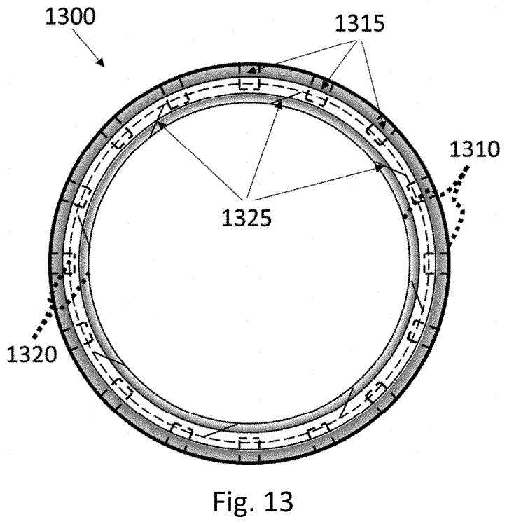

FIG. 13 shows a schematic plan (top) view of still another embodiment of the adaptor (1300). The outer and inner shaded areas indicate the outer (1340) and inner (1350) narrowing regions, where the ring (1310) narrows from the thickness of the central bearing surface (1330. The ring (1310) has 16 slots (1315) (only 3 are labelled) and the cylindrical portion (1320) has 8 apertures (1325) (only 3 are labelled). The center of the first of each pair of slots (1315) is ⅓ of the way between adjacent apertures (1325), while the center of the second of the pair of slots (1315) is ⅔ of the way between the adjacent apertures (1325). In other words, the slots (1315) in these embodiments are rotated by ½ of the angular distance between the slots (1315) relative to the apertures (1325).

In the embodiments shown, the slots (1315) are equally spaced and the apertures (1325) are equally spaced. In some embodiments, at least one slot (1315) is not equally spaced relative to the other slots (1315). In some embodiments, at least one aperture (1325) is not equally spaced relative to the other apertures (1325).

In the embodiments shown, all slots (1315) are the same size and all apertures (1325) are the same size. In some embodiments, at least one slot (1315) is not the same size as the other slots (1315). In some embodiments, at least one aperture (1325) is not the same size as the other apertures (1325).

In all embodiments, no aperture (1325) is adjacent to a slot (1315).

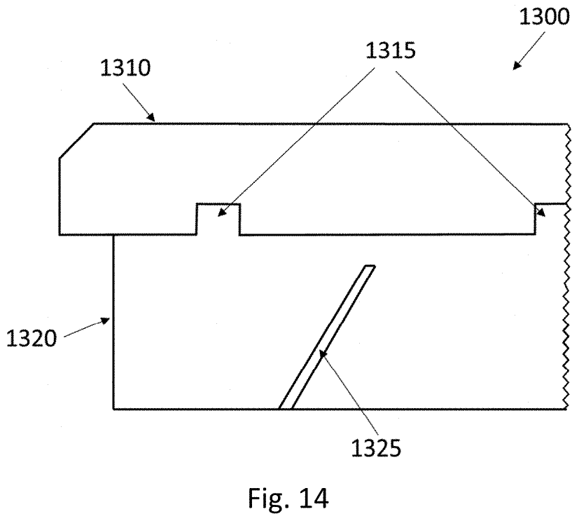

FIG. 14 shows a schematic side view, from the outside, of a section of an embodiment of the adaptor (1300). The slots (1315) are cut into the underside of the ring (1310). The slots are rectangular in cross-section, with a width ranging from 1 mm to 5 mm and a height ranging from 1 mm to 3 mm.

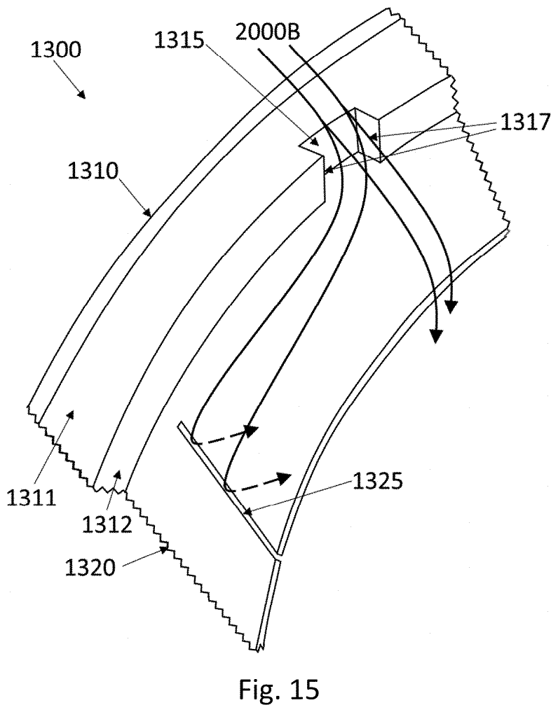

FIG. 15 shows a schematic perspective view, looking upward from the outside, of a section of an embodiment of the adaptor (1300). The ring (1310) protrudes outward from the cylindrical portion (1320); the base (1312) of the ring would rest on the rim of a bottle in use. The slots (1315) are cut into the base (1312) of the ring. In this typical embodiment, the slots (1315) are formed so that their sides (1317) are perpendicular to the outer face (1311) of the ring (1310); each slot has the shape of a rectangular solid.

A path of air (2000B) from the exterior of the adaptor (1300) to the interior of the bottle is illustrated schematically in FIG. 15. The air, after entering the gap between collar (not shown) and bottle (not shown), passes through a slot (1315) in the ring (1310). It can then reach the main part of the interior of the bottle by two routes. One is travel through the gap between the cylindrical portion (1320) and the bottle (not shown) past the bottom of the cylindrical portion (1320). The other is to travel through the gap between the cylindrical portion (1320) and the bottle (not shown) until it reaches a slit (1325) and then to pass through the slit (1325).

In some embodiments, at least one side (1317) of at least one slot (1315) is not perpendicular to the outer face of the ring (1310).

The ring (1310) comprises a rigid biocompatible material such as, but not limited to, polycarbonate, polyethylene, polyphenylsulfone and polypropylene, and the cylindrical portion (1320) comprises a soft, flexible material, preferably silicone.

Preferably, the cylindrical portion (1320) comprises at least one hydrophobic material.

Preferably, the ring (1310) comprises at least one hydrophobic material.

Preferably, the soft flexible material of the cylindrical portion (1320) extends above the base of the ring (1310). In further reference to FIG. 8, the rigid material of the majority of the ring (1310) is indicated by hatching, while the soft, flexible material is indicated by the diagonal lines. The extension of the soft, flexible material above the base of the ring can be clearly seen.

The rigid material of the ring (1310) prevents collapse of the slots (1315) when the collar (1200) is screwed into place to retain the adaptor (1300) and the nipple (1100) on the bottle (1000).

The flexible material of the cylindrical portion (1320) enables movement of the edges of the apertures (1325) during feeding, thus preventing blockage of the apertures (1325). A flexible cylindrical portion (1320) also simplifies placing of the adaptor (1300) in position before use and its removal from the bottle (1000) after use.

Angling of the apertures in the through-thickness directions means that the apertures are longer than they would be if they were cut perpendicularly through the cylindrical portion. The longer apertures help minimize the possibility of leakage of fluid through the cylindrical portion, while permitting passage of gas. Using a longer aperture also enables the apertures to be wider, thereby increasing the volume of air that can enter the bottle via the apertures.

The slots communicate, on their outer side, with a space above the screw threads, so that the screw threads can also help minimize the possibility of leakage from the bottle, while still allowing passage of air.

The slots are near the top of the bottle so that, when the bottle is upright for storage it will not leak, as the fluid will be below the level of the slots. This is unlike those of the prior-art bottles with vents or valves at the bottom of the bottle, where, during storage, the weight of the fluid will tend to cause the vent or valve to open.

1. An adaptor for a feeding bottle, comprising:
a ring with a lower side, an upper side, an inner side and an outer side, said lower side substantially flat, at least a portion of said lower side configured to rest on a rim of said bottle; said ring comprising at least one slot on its lower side; an outer edge of said at least one slot being at said outer side of said ring, said slot not extending to said inner side of said ring; and
a cylindrical portion having an upper side, a lower side, an inner side and an outer side, said upper side integral with a portion of said lower side of said ring; said cylindrical portion depending from said ring; said cylindrical portion configured to be positionable within said bottle and with said outer side close to an inner side of said bottle, an upper portion of said inner side of said cylindrical portion substantially parallel to a lowermost portion of said inner side of said ring;
said cylindrical portion comprising at least one aperture, said at least one aperture having two sides, said at least one aperture passing entirely through said cylindrical portion; each of said two sides of said at least one aperture terminating in an inner side edge on said inner side of said cylindrical portion, an outer side edge on said outer side of said cylindrical portion and a bottom edge on said bottom side of said cylindrical portion;
wherein at least an upper portion of said outer side of said cylindrical portion subtends an angle θ with respect to said inner side of said bottle;
wherein each of said inner edges of said at least one aperture and each of said outer edges of said at least one aperture subtends an angle φ with a vertical perpendicular to said inner edge of said bottom side of said cylindrical portion;
further wherein each of said bottom edges subtends an angle ρ with a horizontal perpendicular to said outer edge of said bottom side of said cylindrical portion.

2. The adaptor of claim 1, wherein said aperture is selected from of a group consisting of: a slit ending at said bottom edge of said cylindrical portion, a slit-shaped hole, and any combination thereof.

3. The adaptor of claim 1, wherein said angle θ is less than 20°.

4. The adaptor of claim 1, wherein said angle φ is in a range between 10 degrees and 80 degrees.

5. The adaptor of claim 1, wherein said angle ρ is in a range between 10 degrees and 80 degrees.

6. The adaptor of claim 1, wherein said at east one aperture is either a slit or a hole.

7. The adaptor of claim 1, wherein said at least one slot is either a slit or a hole.

8. The adaptor of claim 1, wherein said at least one slot has a width selected from a group consisting of: wider at the top than the bottom on the outside, wider at the bottom than the top on the outside, and the same width at the top and the bottom on the outside.

9. The adaptor of claim 1, wherein said at least one slot has a width selected from a group consisting of: wider at the top than the bottom on the inside, wider at the bottom than the top on the inside, and the same width at the top and the bottom on the inside.

10. The adaptor of claim 1, wherein said at least one aperture has a width selected from a group consisting of: wider at the top than the bottom on the outside, wider at the bottom than the top on the outside, and the same width at the top and the bottom on the outside.

11. The adaptor of claim 1, wherein said at least one aperture has a width selected from a group consisting of: wider at the top than the bottom on the inside, wider at the bottom than the top on the inside, and the same width at the top and the bottom on the inside.

12. The adaptor of claim 1, wherein said adaptor comprises hydrophobic material.

13. The adaptor of claim 1, wherein said aperture has a width of less than 0.2 mm.

14. The adaptor of claim 1, wherein the number of slots in the ring is between 1 and 40.

15. The adaptor of claim 1, wherein the number of apertures in the cylindrical portion between 1 and 40.

16. A method for enabling feeding from a bottle with a nipple, comprising steps of:
providing a conventional feeding bottle comprising a bottle portion, a nipple and a collar, said collar reversibly fastenable to said bottle portion, said collar configured to retain said nipple in juxtaposition with said bottle portion;
providing an adaptor for said bottle, said adaptor comprising:
a ring with a lower side, an upper side, an inner side and an outer side, said lower side substantially flat, at least a portion of said lower side configured to rest on a rim of said bottle; said ring comprising at least one slot on its lower side; an outer edge of said at least one slot being at said outer side of said ring, said slot not extending to said inner side of said ring; and
a cylindrical portion having an upper side, a lower side, an inner side and an outer side, said upper side integral with a portion of said lower side of said ring; said cylindrical portion depending from said ring; said cylindrical portion configured to be positionable within said bottle and with said outer side close to an inner side of said bottle, an upper portion of said inner side of said cylindrical portion substantially parallel to a lowermost portion of said inner side of said ring;
said cylindrical portion comprising at least one aperture, said at least one aperture having two sides, said at least one aperture passing entirely through said cylindrical portion; each of said two sides of said at least one aperture terminating in an inner side edge on said inner side of said cylindrical portion, an outer side edge on said outer side of said cylindrical portion and a bottom edge on said bottom side of said cylindrical portion;
at least an upper portion of said outer side of said cylindrical portion subtending an angle θ with respect to said inner side of said bottle;
each of said inner edges of said at least one aperture and each of said outer edges of said at least one aperture subtending an angle φ with a vertical perpendicular to said inner edge of said bottom side of said cylindrical portion; and
each of said bottom edges subtends an angle ρ with a horizontal perpendicular to said outer edge of said bottom side of said cylindrical portion;
placing said adaptor in communication with said bottle portion, with said ring on said rim of said bottle portion and said cylindrical portion within said bottle portion,
placing said nipple in communication with said adaptor;
placing said collar over said nipple; and
fastening said collar to said bottle portion;
thereby providing a non-leaking feeding apparatus.

17. The method of claim 16, additionally comprising a step of selecting said aperture from of a group consisting of: a slit ending at said bottom edge of said cylindrical portion, a slit-shaped hole, and any combination thereof.

18. The method of claim 16, additionally comprising a step of selecting said angle θ to be less than 20°.

19. The method of claim 16, additionally comprising a step of selecting said angle φ to be in a range between 10 degrees and 80 degrees.

20. The method of claim 16, additionally comprising a step of selecting said angle ρ to be in a range between 10 degrees and 80 degrees.

21. The method of claim 16, additionally comprising a step of selecting said at least one aperture to be either a slit or a hole.

22. The method of claim 16, additionally comprising a step of selecting said at east one slot to be either a slit or a hole.

23. The method of claim 16, additionally comprising a step of selecting a width of said at least one slot from a group consisting of: wider at the top than the bottom on the outside, wider at the bottom than the top on the outside, and the same width at the top and the bottom on the outside.

24. The method of claim 16, additionally comprising a step of selecting a width of said at least one slot from a group consisting of: wider at the top than the bottom on the inside, wider at the bottom than the top on the inside, and the same width at the top and the bottom on the inside.

25. The method of claim 16, additionally comprising a step of selecting a width of said at least one aperture from a group consisting of: wider at the top than the bottom on the outside, wider at the bottom than the top on the outside, and the same width at the top and the bottom on the outside.

26. The method of claim 16, additionally comprising a step of selecting a width of said at least one aperture from a group consisting wider at the top than the bottom on the inside, wider at the bottom than the top on the inside, and the same width at the top and the bottom on the inside.

27. The method of claim 16, additionally comprising step of comprising said adaptor of hydrophobic material.

28. The method of claim 16, additionally comprising a step of selecting a width of said at least one said aperture to be less than 0.2 mm.

29. The method of claim 16, additionally comprising a step of selecting the number of slots in the ring to be between 1 and 40.

30. The method of claim 16, additionally comprising a step of selecting the number of apertures in the cylindrical portion to be between 1 and 40.
